(19) United States
(12) Patent Application Publication
(10) Pub. No.: US 2006/0126157 A1
(43) Pub. Date: Jun. 15, 2006

(54) Monolithic integrated semiconductor modulator-SOA-LED broad band light source and method of fabricating the same

(75) Inventors: Moon Ho Park, Daejeon-city (KR); Sahang Gi Park, Daejeon-city (KR); Su Hwan Oh, Daejeon-city (KR); Sung Bock Kim, Daejeon-city (KR); Kwang Ryong Oh, Daejeon-city (KR); Yong Soon Baek, Daejeon-city (KR); Gyung Ock Kim, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/298,387

(22) Filed: Dec. 8, 2005

(30) Foreign Application Priority Data
Dec. 14, 2004 (KR) 10-2004-0105428
Jul. 15, 2005 (KR) 10-2005-0064178

(51) Int. Cl. H01S 3/00

(52) U.S. Cl. 359/333

(57) ABSTRACT

Provided is a monolithic integrated semiconductor broad band light source. In the monolithic integrated semiconductor broad band light source, an electro absorption modulator, a semiconductor optical amplifier, and a light emitting diode are integrated on an InP substrate. Ions are implanted among the electro absorption modulator, the semiconductor optical amplifier, and the light emitting diode to electrically insulate the electro absorption modulator, the semiconductor optical amplifier, and the light emitting diode from one another. Electrodes independently implant currents into the electro absorption modulator, the semiconductor optical amplifier, and the light emitting diode. In particular, it is important to form a current intercepting layer and electrically insulate electrodes from one another but optically connect the electrodes in terms of performance of the monolithic integrated semiconductor broad band light source. The semiconductor optical amplifier and the light emitting diode are integrated into an active layer. As a result, broad band light generated from the light emitting diode is amplified by the semiconductor optical amplifier and modulated by a modulator so as to fabricate a monolithic broad band light source.

### CROSS-REFERENCE TO RELATED PATENT APPLICATION

This application claims the benefit of Korean Patent Application Nos. 10-2004-0105428, filed on Dec. 14, 2004 and 10-2005-0064178, filed on Jul. 15, 2005, in the Korean Intellectual Property Office, the disclosures of which are incorporated herein in their entirety by reference.

### BACKGROUND OF THE INVENTION

1. Field of the Invention

The present invention relates to a monolithic integrated semiconductor modulator-semiconductor optical amplifier (SOA)-light emitting diode (LED) broad band light source usable as a light source for an optical subscriber and a light source for WDM optical communication and a method of fabricating the same.

2. Description of the Related Art

A light transmitter into which an existing electro absorber (EA) modulator and a DFB-LD are integrated is a monolithic frequency light source and thus must control each channel frequency to be used as a multi-channel light source required in an optical communication system using a WDM method. Thus, optical communication systems are complicated and costly. A modulator-SOA-LED according to the present invention is a broad band light source into which a modulator to be used as a light source for an optical subscriber is monolithically integrated. In a case where modulated broad band light is spectrum sliced using an arrayed wavelength grating (AWG), it is suitable to be used for a wavelength division multiplexed (WDM)-passive optical network (PON) light source.

When a spectrum is sliced using an AWG in an optical network unit (ONU) using a WDM-PON method, a light source must have characteristics: (i) a width of a spectrum of a light power must be several tens nm or more; and (ii) an intensity of the light power must be several mW or more. Thus, LEDs, FP-LDs, and DFB-LDs must be improved as follows. Since an LED is easily fabricated and a broad band light source or an intensity of a light power is several hundreds μW or less, an optical subscriber system must use an additional optical amplifier. As a result, the optical subscriber system gradually becomes costly and complicated. In the FP-LDs and the DFB-LDs, a light power is about 10 mw but limited to a narrow band. Thus, optical beat interferences (OBIs) occur between the FP-LDs and the DFB-LDS and adjacent light sources in a subscriber system.

### SUMMARY OF THE INVENTION

A modulator-semiconductor optical amplifier-light emitting diode light source according to the present invention is suggested to solve the above-described problems. A broad band light source into which a modulator is integrated should be developed, the broad band light source being suitable as a light source for an optical subscriber, emitting broad band light having an intensity of about 10 mW. For this purpose, the broad band light source has a 3-electrode structure. In the 3-electrode structure, a semiconductor optical amplifier amplifies broad band light (˜50 nm) having a low intensity generated from a light emitting diode area to 10 times or more. Next, an electro absorption modulator modulates the broad band light. The technical point of the present invention is that the light emitting diode and the semiconductor optical amplifier are integrated into a monolithic active layer, and the monolithic active layer in a modulator area and a window area are removed up to a passive waveguide layer to simultaneously form an optical modulator and a light waveguide.

Accordingly, the present invention also provides a monolithic integrated semiconductor broad band light source and a method of fabricating the monolithic integrated semiconductor broad band light source by which a light absorbing layer inhibits light generated from an active layer from being oscillated so as to effectively generate broad band light emitting diode light and a passive waveguide layer minimizes loss of absorbed light to modulate the broad band light.

According to an aspect of the present invention, there is provided a monolithic integrated broad band light source including: a passive waveguide layer formed on an entire surface of a substrate; a modulator area and a window area disposed on the passive waveguide layer; a semiconductor light amplifier area and a light emitting diode area formed on an active layer pattern on the passive waveguide layer between the modulator area and the window area; and an ion implanted area formed among the modulator area, the semiconductor amplifier area, the light emitting diode area, and the window area to electrically insulate the modulator area, the semiconductor amplifier area, the light emitting diode area, and the window area from one another and a light absorbing layer pattern formed on the active layer pattern beside both sides of the light emitting diode area.

According to another aspect of the present invention, there is provided a method of fabricating a monolithic integrated broad band light source, including: providing a substrate; sequentially forming a passive waveguide layer, an active layer, and a light absorbing layer on the substrate; removing a portion of the light absorbing layer using a first etch mask for patterning the light absorbing layer to form a light absorbing layer pattern; removing a portion of the active layer using a second etch mask covering the light absorbing layer pattern and defining a portion in which a modulator area and a window area are to be formed to form a light resonance stripe having a ridge shape in which a semiconductor light amplifier and a light emitting diode are to be formed; forming a clad layer and an ohmic contact layer covering the light resonance stripe; and implanting ions into the clad layer among the modulator area, the semiconductor light amplifier area, the light emitting diode area, and the window area to electrically insulate the modulator area, the semiconductor light amplifier area, the light emitting diode area, and the window area from one another and forming a first metal electrode for implanting a current into the ohmic contact layer.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of an epitaixal layer firstly grown using Metal Organic Chemical Vapor Deposition (MOCVD);

FIG. 2 is a cross-sectional view of a photoresist formed only on an upper portion of a light adsorbing layer to etch the light absorbing layer;

FIG. 3A is a cross-sectional view of a light absorbing layer formed at both ends of an LED area;

FIG. 3B is a perspective view of the light absorbing layer shown in FIG. 3A;

FIG. 4 is a cross-sectional of a second nitride layer grown to etch a modulator area;

FIG. 5 is a cross-sectional of the second nitride layer etched in the modulator area and a window area;

FIG. 6A is a cross-sectional view of an active layer wet etched in the modulator area and the window area;

FIG. 6B is a perspective view of the active layer shown in FIG. 6A;

FIG. 7A is a cross-sectional view of a p-Inp clad layer and a p-InGaAs ohm contact layer grown using MOCVD;

FIG. 7B is a perspective view of the p-Inp clad layer and the p-InGaAs ohm contact layer;

FIG. 8 is a cross-sectional of a photoresist layer formed as an ion implantation mask using photolithography;

FIG. 9A is a cross-sectional view of an area implanted with ions;

FIG. 9B is a perspective view of the area shown in FIG. 9A;

FIG. 10 is a cross-sectional view of a third nitride layer grown to form a current implantation area;

FIG. 11A is a cross-sectional view of an ohm contact metal deposited in the modulator area, an SOA area, and an LED area; and

FIG. 11B is a perspective view of the ohm contact metal shown in FIG. 11A.

### DETAILED DESCRIPTION OF THE INVENTION

Hereinafter, a preferred embodiment of the present invention will be described in detail with reference to the attached drawings so that those skilled in the art to which the present invention pertains can easily understand the technical contents of the present invention.

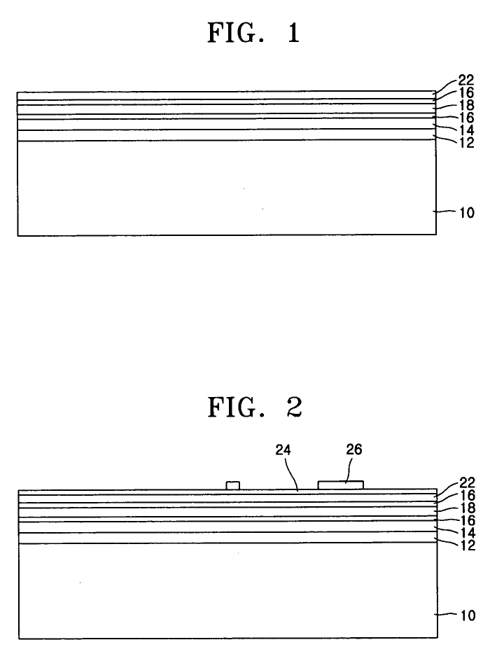

FIG. 1 is a cross-sectional view of an epitaxial layer firstly grown using MOCVD. Referring to FIG. 1, a buffer layer 12, a passive waveguide layer 14, an etch stopper 16, an active layer 18, and an adsorbing layer 22 are grown from an n-type InP substrate 10 using MOCVD. Here, the buffer layer 12 is grown out of n-Inp, the passive waveguide layer 14 is grown out of undoped InGaAsp (λ=1.48 μm, thickness=0.3 μm), and the etch stopper 16 that is to be used as an etch mask during wet etching is grown out of InP (thickness=10 nm). The active layer 18 is formed by growing a separate confinement heterostructure (SCH) (λ=1.3 μm, thickness=0.07 μm) and then a 0.8% InGaAsP strained well layer (λ=1.3 μm, thickness=7 nm), an unstrained InGaAsP barrial layer (λ=1.68 m, thickness=11.5 nm), and an SCH (λ=1.3 μm, thickness=0.07 μm). An etch stopper 16 is grown out of InP to a thickness of about 10 nm on the active layer 18 so as to be used as a wet etch mask during etching of the light absorbing layer 22. The light absorbing layer 22 is grown out of InGaAsP (λ=1.68 μm, thickness=0.1 μm). The light waveguide layer 14 may be formed so as to inclined toward a surface emitting light at an angle of about 7°.

FIG. 2 is a cross-sectional view of a photoresist formed only on an upper portion of the adsorbing layer 22 to etch the light absorbing layer 22. As shown in FIG. 2, a first nitride layer 24 (an oxide including SiO_{X}, SiN_{X}) is formed to a thickness of 0.2 μm on the light absorbing layer 22 using plasma enhanced CVD (PECVD). A first photoresist stripe pattern 26 having [100] direction is formed to a line width of 2 μm on the first nitride layer 24 using photolithography.

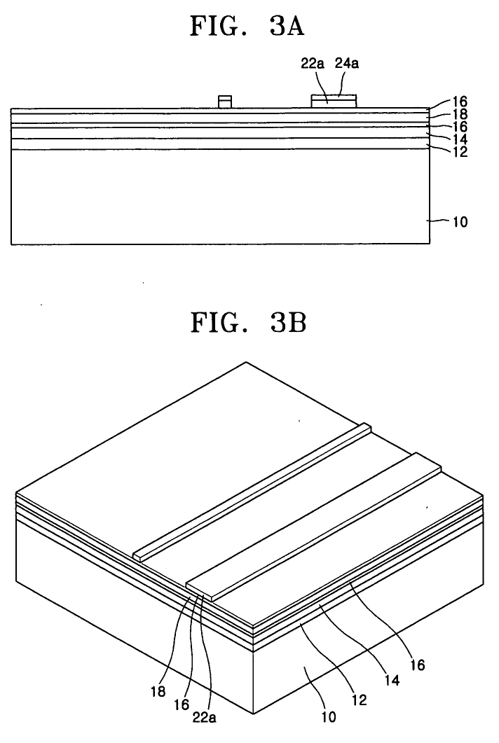

FIG. 3A is a cross-sectional view of the light absorbing layer 22 formed at both ends of an LED area, and FIG. 3B is a perspective view of the light absorbing layer 22 shown in FIG. 3A. As shown in FIG. 3A, the first photoresist stripe pattern 26 is used as a mask to etch the first nitride layer 24 using MERIE and then removed. As shown in FIG. 3B, the first nitride layer 24 is used as a mask to etch the light absorbing layer 22 for about 120 seconds using H₂SO₄:H₂O₂:H₂O=1:1:10.

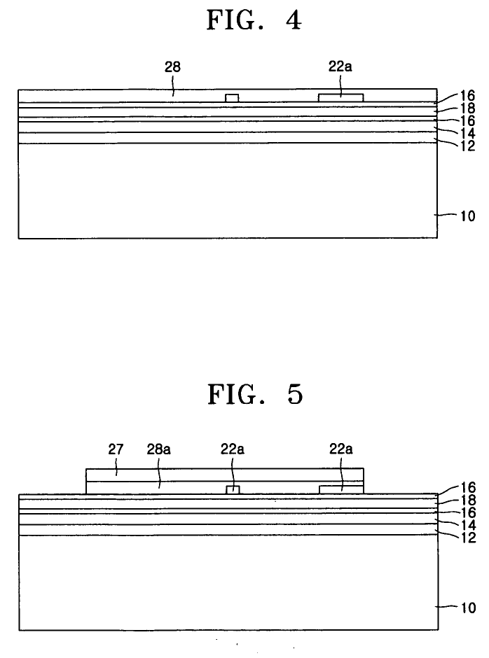

FIG. 4 is a cross-sectional view of a second nitride layer 28 deposited on a whole surface of a resultant structure in which a first nitride pattern 24a on the light absorbing layer 22 is removed. As shown in FIG. 5, a portion of the second nitride layer 28 except portions of the second nitride layer 28 in SOA and LED areas is removed using a buffed oxide etchant (BOE). Reference numerals 22a and 24a denote patterns respectively formed by etching the light absorbing layer 22 and the first nitride layer 24. Here, a second photoresist pattern 27 is used to etch the second nitride layer 28.

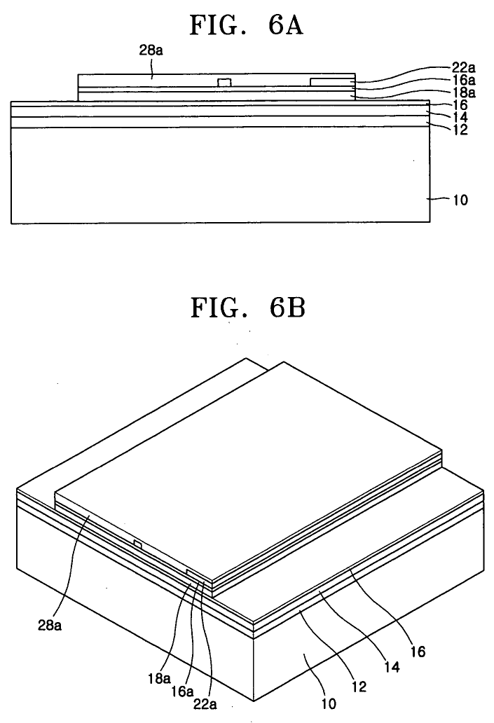

As shown in FIG. 6A, the etch stopper 16 is etched for about 60 seconds using H₃PO₄:HCl=15:85. As shown in FIG. 6B, the active layer 18 is etched for about 120 seconds using H₂SO₄:H₂O₂:H₂O=1:1:10. Portions of the active layer 18 in the modulator and window areas are removed to form a resonance stripe having a width of 2 μm in a ridge shape in the [110] direction in the SOA area, the LED area, and the window area. This process is performed as follows: (i) the second nitride layer 28 used as the etch mask is removed, a nitride layer is deposited on the whole surface, and a nitride stripe having a width of 2 μm is formed in the [110] direction using photolithography and MERIE dry etching; (ii) dry etching is performed up to the passive waveguide layer 14 using the oxide stripe pattern as a mask; and (iii) to remove a surface layer damaged by the dry etching, the surface layer is cleaned for 2 minutes using a sulfuric acid solution and then etched to a thickness of about 10 nm for 60 seconds using HBr:H₂O₂:H₂O=8:2:100. After the waveguide ridge is formed, an epitaxial layer is grown out of p-InP to cover the ridge pattern using MOCVD.

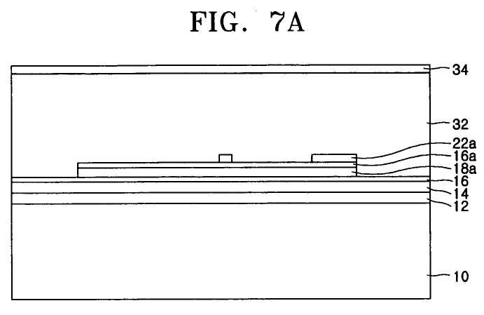

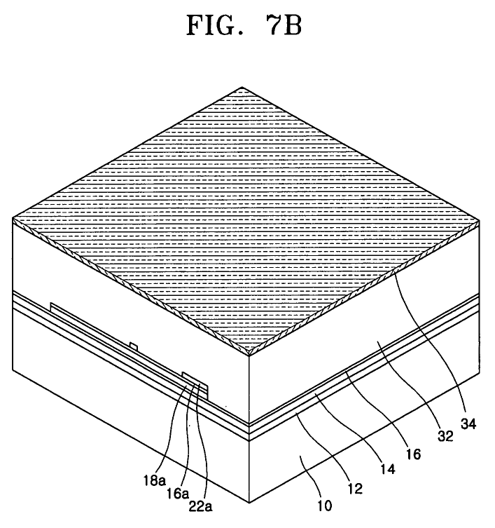

As shown in FIGS. 7A and 7B, a clad layer 32 is grown out of p-Inp and an ohm contact layer 34 is grown out of p-InGaAs using MOCVD so as to form a BRS. InP is grown to a thickness of 0.1 μm on p-InGaAs so as to serve as a passivation layer and to remove a photoresist remaining after an ion implantation process. The clad layer 32 is formed of p-InP to a thickness of 1.8 μm and to doping density of 2×10¹⁸ ions/cm² so as to minimize an ohm resistance.

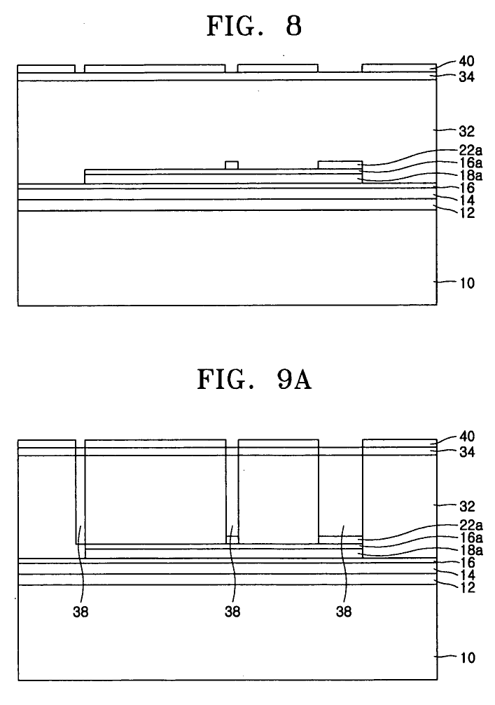

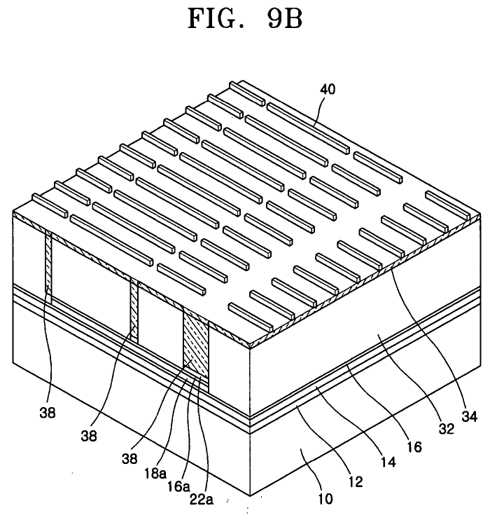

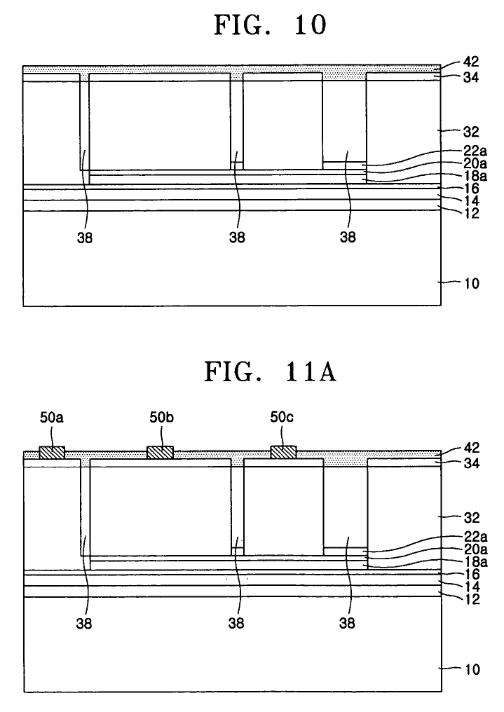

After the BRS is grown, a current is implanted only into the resonance stripe area, and ions must be implanted into the other area to form a high resistance so as to limit a current. As shown in FIG. 8, a photoresist stripe pattern 40 having a thickness of 10 μm and a width of 10 μm is formed on the clad layer 32 to protect the active layer 18 during implanting of the ions. FIG. 9A is a cross-sectional view of an area implanted with ions, and FIG. 9B is a perspective view of the area shown in FIG. 9A. An ion implantation process must be optimum with respect to parameters such as a type of implanted ions, an accelerating voltage, and a dose. In the present invention, H+ ions are mainly used, the accelerating voltage is about several hundreds KeV and varies with the thickness of p-InP, and the doses is 2×10¹⁴ ions/cm². An ion implanted area 38 is an entire area except an area in which the photoresist stripe pattern 40 used as an ion implantation mask is formed. Also, ions are implanted among the modulator area, the SOA area, and the LED area so as to electrically insulate the modulator area, the SOA area, and the LED area from one another. The photoresist stripe pattern 40 which has been used as the ion implantation mask is heated by ACT-1 and then removed by plasma ashing. Thereafter, InP on the uppermost layer is etched for 2 minutes using H₃PO₄:HCl=85:15. A remaining photoresist is completely removed by this etching process.

FIG. 10 is a cross-sectional view of a third nitride layer 42 deposited after the PR used as an ion implantation mask is removed.

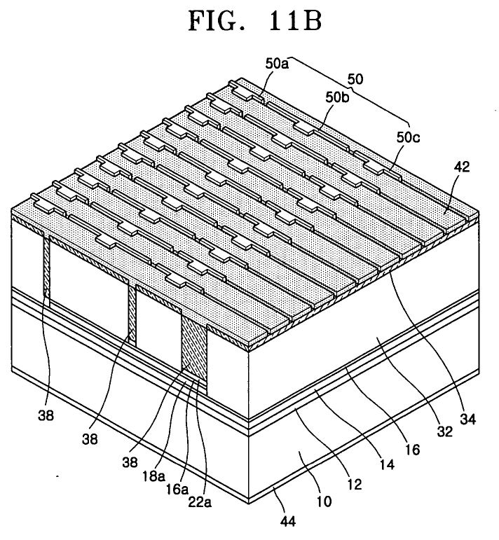

Referring to FIGS. 11A and 11B, current implanted stripe (modulator, SOA, and LED) areas are patterned on the third nitride layer 42 by image reversal photolithography. Next, portions of the third nitride layer 42 in the modulator, SOA, and LED areas are etched by MERIE. Thereafter, Au(300 nm)/Pt(30 nm)/Ti(30 nm) are deposited using an electronic beam depositor to form a p-type metal electrode. After the p-type electrode 50 is formed, an annealing process for an ohmic contact is performed. Next, the substrate 10 is lapped to a thickness of about 100 μm. Thereafter, an n-type metal (Au/Cr) 44 is deposited underneath the substrate 10 and then annealed. Reference numerals 50a, 50b, and 50c denote metal electrodes in the modulator, SOA, and LED areas, respectively.

A monolithic integrated semiconductor modulator-SOA-LED light source according to the present invention can be used as a light source for optical subscribers, a light source for a broad band WDM-PON, or a light source for an optical image system requiring a broad band light source.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A monolithic integrated broad band light source comprising:
a passive waveguide layer formed on an entire surface of a substrate;
a modulator area and a window area disposed on the passive waveguide layer;
a semiconductor light amplifier area and a light emitting diode area formed on an active layer pattern on the passive waveguide layer between the modulator area and the window area; and
an ion implanted area formed among the modulator area, the semiconductor amplifier area, the light emitting diode area, and the window area to electrically insulate the modulator area, the semiconductor amplifier area, the light emitting diode area, and the window area from one another and a light absorbing layer pattern formed on the active layer pattern beside both sides of the light emitting diode area.

2. The monolithic integrated broad band light source of claim 1, wherein the window area, the light emitting diode area, the semiconductor light amplifier area, and the modulator area are sequentially arranged.

3. The monolithic integrated broad band light source of claim 1, wherein the light absorbing layer pattern is formed under the ion implanted area among the semiconductor light amplifier area, the light emitting diode area, and the window area.

4. The monolithic integrated broad band light source of claim 1, wherein the light absorbing layer pattern inhibits absorbed light from being oscillated.

5. The monolithic integrated broad band light source of claim 1, wherein the modulator area, the semiconductor light amplifier area, and the light emitting diode are independently implanted with currents.

6. The monolithic integrated broad band light source of claim 5, wherein the modulator area, the semiconductor light amplifier area, and the light emitting diode area respectively contact a first metal electrode supplying a power.

7. The monolithic integrated broad band light source of claim 1, wherein the ion implanted area is covered with a third nitride layer.

8. A method of fabricating a monolithic integrated broad band light source, comprising:
providing a substrate;
sequentially forming a passive waveguide layer, an active layer, and a light absorbing layer on the substrate;
removing a portion of the light absorbing layer using a first etch mask for patterning the light absorbing layer to form a light absorbing layer pattern;
removing a portion of the active layer using a second etch mask covering the light absorbing layer pattern and defining a portion in which a modulator area and a window area are to be formed to form a light resonance stripe having a ridge shape in which a semiconductor light amplifier and a light emitting diode are to be formed;
forming a clad layer and an ohmic contact layer covering the light resonance stripe; and
implanting ions into the clad layer among the modulator area, the semiconductor light amplifier area, the light emitting diode area, and the window area to electrically insulate the modulator area, the semiconductor light amplifier area, the light emitting diode area, and the window area from one another and forming a first metal electrode for implanting a current into the ohmic contact layer.

9. The method of claim 8, wherein the passive waveguide layer, the active layer, and the light absorbing layer are formed using a Metal Organic Chemical Vapor Deposition.

10. The method of claim 8, wherein the clad layer electrically insulates the modulator area, the semiconductor light amplifier area, and the light emitting diode area from one another.

11. The method of claim 8, wherein the light waveguide layer is formed to inclined toward a surface emitting light at an angle of about 7°.

12. The method of claim 8, wherein a non-reflective coating layer is formed on the surface emitting the light.

13. The method of claim 8, before the first metal electrode is formed, comprising:
removing the ohmic contact layer on the clad layer; and
forming a third nitride layer covering the ohmic contact layer and the clad layer.
